(19) United States
(12) Patent Application Publication
(10) Pub. No.: US 2013/0060713 A1
(43) Pub. Date: Mar. 7, 2013

(54) Receipt digitizing method for retail customers

(71) Applicant: Xun Xu, San Jose, CA (US)

(72) Inventor: Xun Xu, San Jose, CA (US)

(73) Assignee: Xun Xu, San Jose, CA (US)

(21) Appl. No.: 13/507,291

(22) Filed: Jun. 18, 2012

Related U.S. Application Data
(62) Division of application No. 13/134,934, filed on Jun. 21, 2011, now abandoned.

(51) Int. Cl. G06Q 40/00

(52) U.S. Cl. 705/342; 705/14.4

(57) ABSTRACT

Method of receipt digitizing is disclosed. Retail customers create digital copies of paper receipts with a kiosk system before they leave. The digital copies are sent to customers' online space. This low cost method benefits customers with a centralized and organized means of keeping their receipts, and provides retailers a better way of delivering promotion information to relevant recipients. The solution is also good to the environment because it cuts coupon printing and increases awareness of the convenience of digital receipts. This awareness will eventually lead to the final phase out of paper receipt printing.

### CROSS-REFERENCE TO RELATED APPLICATIONS

This is a divisional application of prior application Ser. No. 13/134,934.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM, LISTING COMPACT DISC APPENDIX

Not applicable.

### BACKGROUND OF THE INVENTION

To many people, keeping shopping receipts is a headache. Some people put them in shoeboxes after they get home. Some just throw receipts anywhere one can imagine, in pockets, in purses, in cars, in shopping bags, just naming a few. Most of the time, they don't need these receipts anymore. However, when exceptions really come, people usually have to spend a lot of time digging these months old receipts out in order to get refunds, or to file them in tax returns. To cover these rare exceptions, nearly every shopping transaction generates a paper receipt that would most likely be thrown away shortly. Since millions of retail transactions take place every day, environmental impact caused by receipt printing is huge. Making things worse, many stores also print coupons along with the receipts, no matter customers need them or not. Unlike regular printing paper, thermal receipt paper cannot be recycled due to chemicals in it. Though the chemicals could be handled in specialized facilities, it is simply too costly to have this type of paper sorted out from other recyclable goods. Therefore, year from year, thousands of tons of receipt printing paper ends up in land fill.

Considering of the negative side of paper receipt, some people promote digital version of receipts. Many Apple stores now give customers the option of sending an electronic copy of the receipt directly to their email accounts when they checkout [1]. Some companies, such as alletronics.com let stores send receipts to special online receipt accounts [2]. Back at home, when customers need to access their receipts, they need to login to these accounts to retrieve them. Compared with paper receipts, digitized ones are a lot more organized, and when customers choose to skip printing, paper is saved, which benefits the environment. However, one obstacle facing the above solutions is upfront cost to the retailers. The POS (Point of Sell) systems need new software, and the checking-out clerks need additional training. Some estimates the upfront cost could be as high as $60,000 to $100,000 for a large chain [1]. For customers, the requirement of another online enrollment makes the solutions of alletronics.com a lot less desirable.

It is within this context that embodiments of the present invention arise.

### BRIEF SUMMARY OF THE INVENTION

In this application, a customer self-service receipt-digitizing kiosk system is disclosed as an alternative solution. The basic idea is, after a customer finishes the shopping, before he/she leaves, he/she can go to the receipt-digitizing kiosk to make a digital copy of his/her paper receipt, and the digital copy is instantly sent to his/her online space. The online space could be things like an email account, online storage account, etc. The main attractiveness of this solution is low cost. The system cost should be well below $2,000, and it has no impact on existing POS structure. Like other digital receipt solutions, the kiosk benefits customers with an organized way of keeping receipts, and benefits retailers with a better customer experience, as well as a more effective way of delivering coupons, which is sending coupons with receipt copies.

### BRIEF DESCRIPTION OF THE SEVERAL VIEWS OF THE DRAWING

The teachings of the present invention can be readily understood by considering the following detailed description in conjunction with the accompanying drawings, in which:

FIG. 1 is a diagram illustrating a typical kiosk configuration of the receipt digitizing system.

FIG. 2 is a flow diagram illustrating the system's processing flow in running mode.

FIG. 3 is a diagram illustrating a receipt digitizing scenario when transaction indices are printed on receipts.

FIG. 4 is a flow diagram illustrating the system's processing flow of the scenario in FIG. 3.

### DETAILED DESCRIPTION OF THE INVENTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to an without imposing limitations upon, the claimed invention.

### I. Introduction

A customer self-service receipt-digitizing kiosk system 100 is disclosed as an alternative means to existing solutions. The basic idea is, after a customer finishes the shopping, before he/she leaves, he/she can go to the receipt-digitizing kiosk to make a digital copy of his/her paper receipt 102, and the digital copy is instantly sent to his/her online space. The online space could be things like an email account, online storage account, etc.

The main attractiveness of this solution is low cost. The system cost should be well below $2,000, and it has no impact on existing POS structure. Like other digital receipt solutions, the kiosk benefits customers with an organized way of keeping receipts, and benefits retailers with a better customer experience, as well as a more effective way of delivering coupons, which is sending coupons with receipt copies.

One may argue that this method does not cut paper printing, so it is not eco-friendly. As the matter of fact, this solution benefits the environment at least in 3 ways. First, since the retailer has a better way of delivering coupons, there is no need for them to print them on paper with the receipts. In another word, the solution cuts coupon printing. Second, if customers feel comfortable enough to keep only digital copies, they can discard paper receipts in a receipt-collecting bin beside the kiosk. Receipts collected will be recycled in special facilities. Therefore, this method increases the possibility of recycling thermal receipt paper. Third, this is an extremely effective way of letting more customers experience the convenience of digital receipt. After digital receipt gained enough populace among customers, customer desire would push retailers to upgrade POS software and cut receipt printing. This kiosk solution serves as a step stone to the final digitization of all shopping receipts.

The rest of the decription is organized as follows. Section II describes the structure of the kiosk system 101. Section III has discussions on possible running business models, setup scenarios and feature expansions. Section IV gives the cited references.

### II. System Structure

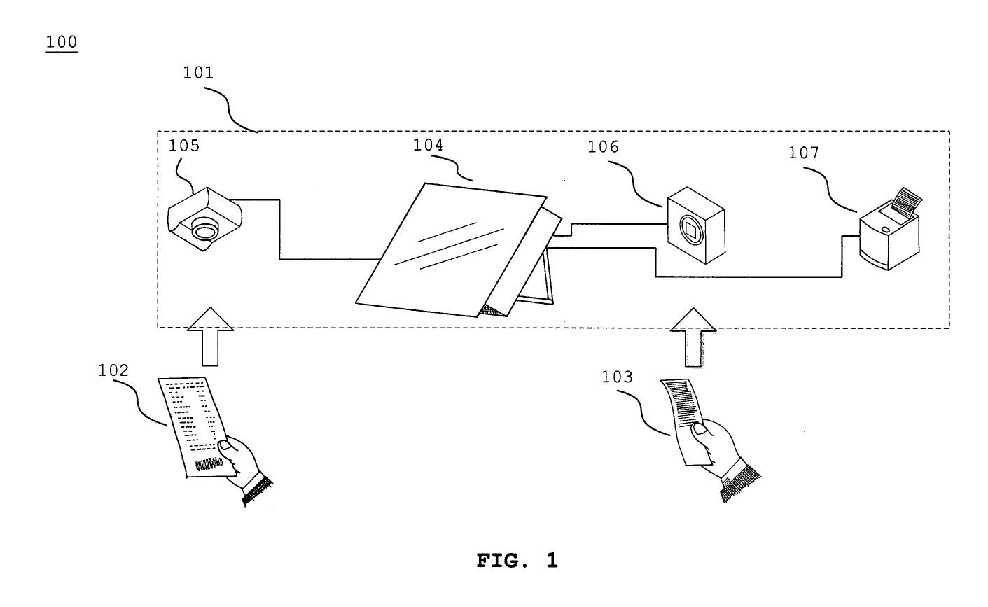

The kiosk system 101 consists of an imaging device 105, an optical data reader 106, a label printer 107, and of cause a host unit 104 (FIG. 1).

The imaging device 105 is used to capture digital copies of paper receipts 102. Most popular imaging devices are digital cameras and scanners. For the same cost, the resolution of a camera tends to be lower than a scanner. But a camera acquires a 2D image much quicker than a scanner, be it pass through or flatbed. One needs to balance resolution and customer throughput when making the selection.

Customers input his/her electronic ID that has been printed in optical data format through the optical data reader 106. The electronic ID can be a conventional email address, an instant messenger ID, or any ID that identifies an online destination exclusive to a customer. Optical data format 103 here refers to printable graphs or images that represent customers' electronic IDs, and can be read by a machine. An example of this kind of optical data format is barcode 103, and in this example, the optical data reader 106 is a barcode scanner 106. Scanning barcodes would be a lot easier and faster than manually entering the ID on a keyboard.

For first time customers, most likely they do not have their electronic ID printed in optical data format 103. They need to manually input the ID for the first time; the label printer 107 prints the ID in optical data format on a small piece of label. So the next time, customer can input the ID through the optical data reader instead of typing the ID again. For customer's convenience, system may send customers' electronic ID in optical data format together with receipt copies. Customers can print them at home and carry with them.

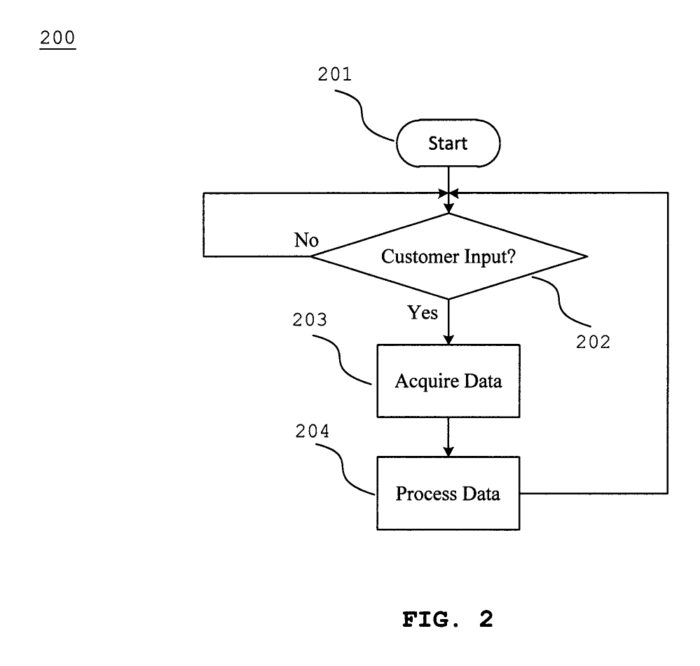

The imaging device 105, the optical data reader 106 and the label printer 107 are all connected to a host unit 104. The host unit 104 doesn't have to be a computer. It can be any processing modules or logical circuitries that run application software, be it implemented in ASIC, FPGA or anything else. In running mode 200, the application software's basic tasks include interacting with customers 202, acquiring digital receipt copies 203 from the imaging device, performing necessary processing on these copies 204, acquiring customers' electronic ID 203 that identifies an online destination, printing electronic ID in optical data format 204, communicating with outgoing servers 204, and sending receipt copies via broadband interne connection 204. FIG. 2 gives the flowchart 200 of an example implementation of the running mode. In maintenance mode, the application software interacts with retailers to arrange promotion materials sent with receipt copies, generating statistical information, as well as other maintenance tasks. Like most kiosk systems, the host unit has a UI (User Interface) to interact with its users. The UI can be implemented with things like touch screen, keyboard, and function keys, etc. Basic tasks mentioned above are relatively simple. Even very low cost hardware and software have enough computing power to carry them out.

### III. Discussion

The kiosk solution gives retailers a more effective way of delivering promotion information, which “pushes” promotion information to customers' online space. In addition, with shopping receipts and customers' electronic ID in records, retailers can easily build shopping profiles for individual customers. Tailored according to these profiles, promotion could be a lot more focused and effective. Considering of these benefits, most retailers are willing to cover the small cost of setting up and maintaining the system, and let customers create and send digital copies of receipts free of charge. On the other hand, for customers, if receipt digitizing really brings them convenience, most of them won't mind paying a small fee for using this type of service, as long as the fee is truly small and it is easy to make the payment. The fee could be charged on number of receipts sent or based on subscriptions tied to each electronic ID. If the solution becomes popular with customers, this type of fee helps to offset the cost of running the system and return a profit.

If network bandwidth is enough and optical data reading is used to input customers' electronic IDs, a customer could commence receipt digitizing and sending in seconds. With throughput as fast as this, one kiosk system would be enough to cover customer flow of over 10 POS terminals. Therefore, it is a good idea for midsize retailers, such as grocery stores to keep a system inside each store, and let customers digitize receipts on their way out. For aggregations of retailers with small number of POS terminals, such as restaurants and booths, the digitizing station should be kept in a shared place that can be accessed by all nearby customers and patrons.

Some receipt digitizing solutions propose using magnetic strip reading as the way of input destination information of customer. Here in this solution, optical data, especially 2D or 3D barcode is preferred due to the low cost of printing barcode labels, compared with issuing magnetic strip cards. The labels are quite small and can be stick to many convenience surfaces and carried around. Good examples of these surfaces are, back of cell phone, upper front of credit cards, inner fold surfaces of wallets, etc. Customers may favor this approach over squeezing another card into an already stuffed wallet.

In this solution, paper receipts are digitized by imaging devices. Therefore, the electronic copy is fundamentally image-based. Compared with the receipt copy sent directly from an upgraded POS terminal, which is text based, the one sent by the kiosk takes more bandwidth and is less ready to be exported to accounting software. However, the lack of efficiency is perhaps the price we have to pay if retailers want to save the cost of upgrading existing POS terminals, and let more customers enjoy the convenience of digitized receipts. When the day comes that majority of customers prefer digital receipts over paper ones, retailer would be more than happy to retrofit for enhanced customer experience. In this case, the scanners that are used to scan UPC codes would also double as the optical data reader for inputting customers' electronic IDs. At current stage, third party software vendors may fill in the efficiency gap by creating software means for customers downloading receipts and extracting text information from image files. Retailers may also use this kind of software to analyze outgoing receipt copies and build customer profiles.

The receipt digitizing station doesn't have to take form of an individual kiosk. It may be integrated into existing kiosk systems as a new feature to save store hallway space. Also, the digitizing station can be used to digitize and send other documents, not only limited to shopping receipts. This is beneficial to retailers, because people who only come to use the in-store digitizing service also get a copy of promotional information, and since they are already in the store, in many cases they also do some shopping before they leave.

In case the host unit have enough processing power, it may perform some tasks like OCR (optical character recognition) to extract text information out of the just acquired digital copy of receipt, which is image based. The system may send the text-based copy together with the image-based one together. The text-based digital copy is easier to be loaded in accounting software.

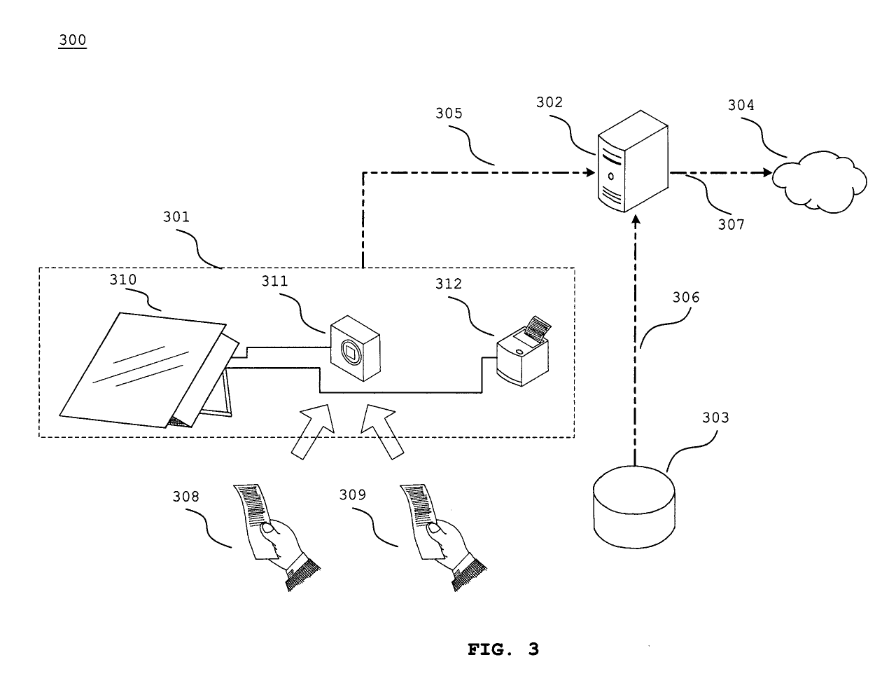

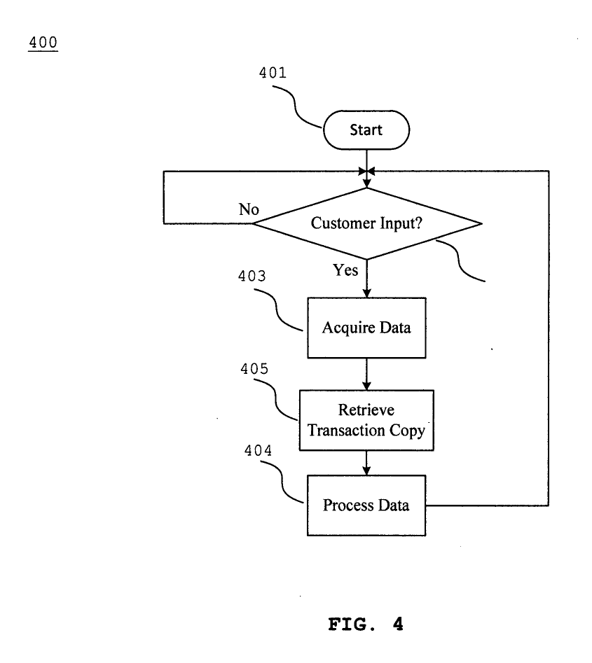

For some retailers, as soon as a transaction is commenced, a digital copy of this transaction is saved in a centralized database 303. Barcode of index information that identifies this transaction is printed on customer's paper receipt. To send the digital copy, the customer only needs to scan the index barcodes 308 as well as his/her electronic ID 309. A processing unit will retrieve the transaction information 306 and send it to customer's online space 304. The digital copy 307 of the transaction may or may not take the form of receipt, but most likely the transaction information is text based for efficiency of sending and storage. In this scenario 300, the kiosk system in FIG. 1 serves as a terminal for inputting transaction index 308 and customers electronic ID 309, as well as printing the ID in optical data format if needed. The imaging device may be omitted, and the optical data reader 311 doubles as an ID input device and a transaction index input device (FIG. 3). FIG. 4 is the processing flowchart of an example implementation.

Instead of directly sent to customers' email accounts, receipt copies can be sent to a centralized place, like what alletronics.com proposed. Storage space on and bandwidth to customers' online server could be saved. However, it would be nice if some sort of brief messages, such as a text message or email were “pushed” to customers as a reminder or instruction of retrieving the receipts.

Step 2 202 402 in FIG. 2 or FIG. 4 could be implemented with sensors. The sensors automatically detect things like the approaching of a customer, the presentation of a paper receipt to the imaging/scanning device, presentation of a customer electronic ID to the optical data reader, or any other signals related to the readiness of a customer using the digitizing service. Alternatively, the customer could just press a start key/button on the UI to start the digitizing operation.

Web-based service is getting more and more popular. Considering of this, the digitized receipt copy can be directly sent to web-based accounting/financial services, instead of letting customers download them and export them manually on their home computers.

Customers' electronic ID label can be also used in other occasions that needs contact information input. For example, using a smart phone that runs camera-based barcode recognition software, one can create a contact entry in seconds. First take a picture of the new friend, then scan his/her electronic ID barcode.

Items bearing customer's electronic ID labels are actually tagged with owners' contact info. This piece of information increases the chance of recovery in case the items are misplaced or lost.

### IV REFERENCES

1. http://ideas.blogs.nytimes.com/2009/11/10/why-paper-receipts-wont-die/
2. http://www.alletronic.com/

What is claimed is:

1. A method of document digitizing comprising: a step of aquiring user's electronic ID; said electronic ID identifies user's online destination.

2. The method in claim 1 further comprising: a step of sending the digital copy of the document to the online destination in claim 1.

3. The method in claim 1 further comprising: a step of sending the digital copy to a centralized space; and a step of sending a message to user's online destination, said message is about the digital copy is sent, and about how to retrieve the digital copy.

4. The method in claim 1 further comprising: a step of sending the digital copy in claim 1 to web based accounting service; and a step of sending user a message about the sending of the digital copy.

5. The method in claim 1 further comprising: a step of capturing digital copy of user document by a imaging device.

6. The method in claim 1 further comprising: a step of reading a index that identifies the digital copy in claim 1, wherein the digital copy has been saved in a database; and a step of retrieving the digital copy by the index.

7. The method in claim 1 further comprising: a step of printing user's electronic ID in optical data format.

8. The step of aquiring user's electronic in claim 1 further comprising: manually input the electronic ID.

9. The step of aquiring user's electronic in claim 1 further comprising: reading electronic ID through a optical data reader, provided the electronic ID is already printed in optical data format, said optical data format is printable images, represents data and can be read by a machine.

10. The optical data format in claim 9 is selected from a group consisting of 1D barcode and 2D barcode

11. The method in claim 1 further comprising: the step of sending promotional information together with the digital copies recited in claim 1.

12. The method in claim 3 further comprising: the step of sending promotional information together with the message, said massage is selected from a group consisting of the message in claim 3, and the message in claim 4.

13. The document in claim 1 is a receipt, said receipt records a transaction.
